(19) United States
(12) Patent Application Publication
(10) Pub. No.: US 2015/0224967 A1
(43) Pub. Date: Aug. 13, 2015

(54) Trailer Jack

(71) Applicant: Rodney Lee Rensink, Boyden, IA (US)

(72) Inventor: Rodney Lee Rensink, Boyden, IA (US)

(21) Appl. No.: 14/178,942

(22) Filed: Feb. 12, 2014

(51) Int. Cl. B60S 9/10; B66F 3/24

(52) U.S. Cl. CPC B60S 9/10; B66F 3/24; B66F 3/247

(57) ABSTRACT

Disclosed is a jack that may include a first assembly having a first side wall and a second side wall, a second assembly having a third side wall and a fourth side wall, a pin connecting the first assembly to the second assembly so that the first assembly is rotatably connected to the second assembly, and at least one actuator connected to the first assembly and the second assembly.

### CROSS-REFERENCE TO RELATED APPLICATIONS

This application claims priority to U.S. Patent Application Ser. No. 61/764,736 filed with the United States Patent and Trademark Office on Feb. 14, 2013, the entire contents of which is herein incorporated by reference.

### BACKGROUND

1. Field

Example embodiments are directed to a jack, for example, a trailer jack.

2. Description of the Related Art

Jacks are commonly used to raise, lower, and support a trailer. Many conventional jacks use hydraulic cylinders as a means for actuating the jack. In heavy load applications, the cylinders may be quite expensive and thus, may be cost prohibitive.

### SUMMARY

Example embodiments are directed to a jack, for example, a trailer jack.

In accordance with example embodiments a jack may include a first assembly, a second assembly pivotally connected to the first assembly, a locking assembly pivotally connected to the first assembly and having an end configured to engage an interfacing member arranged in the second assembly, and at least one actuator configured to rotate the first assembly with respect to the second assembly. In example embodiments, the jack may further include a second actuator configured to pivot the locking assembly. In example embodiments each of the at least one actuator and the second actuator may be double acting actuators.

### BRIEF DESCRIPTION OF THE DRAWINGS

Example embodiments are described in detail below with reference to the attached figures, wherein:

FIG. 1A is a perspective view of a jack in accordance with example embodiments;

FIG. 1B is a first side view the jack in accordance with example embodiments;

FIG. 1C is a second side view of the jack in accordance with example embodiments;

FIG. 1D is a top view of the jack in accordance with example embodiments;

FIG. 1E is a front view of the jack in accordance with example embodiments;

FIG. 2A is a top view of a first assembly of the of the jack in accordance with example embodiments;

FIG. 2B is a side view of the first assembly of the of the jack in accordance with example embodiments;

FIG. 2C is a front view of the first assembly of the of the jack in accordance with example embodiments;

FIGS. 3A and 3B are views of a base of the first assembly in accordance with example embodiments;

FIGS. 4A and 4B are view of a lock bar pin in accordance with example embodiments;

FIG. 5 is a view of a lock bar side plate in accordance with example embodiments;

FIGS. 6A and 6B are views of a lock bar spring plate in accordance with example embodiments;

FIGS. 7A and 7B are views of a lock bar plate in accordance with example embodiments;

FIG. 8 is a view of a lock bar assembly in accordance with example embodiments;

FIGS. 9A and 9B are views of a second assembly of the jack in accordance with example embodiments;

FIGS. 10A and 10B are views of a base plate of the second assembly in accordance with example embodiments;

FIGS. 11A and 11B are views of a back plate of the second assembly in accordance with example embodiments;

FIGS. 12A and 12B are views of a front plate of the second assembly in accordance with example embodiments;

FIGS. 13A and 13B are views of a side plate of the second assembly in accordance with example embodiments;

FIG. 14 is a view of a lock bar saw tooth in accordance with example embodiments;

FIGS. 15A-15E are views of various components of a locking handle in accordance with example embodiments;

FIG. 16 is a view of a rear pin in accordance with example embodiments;

FIG. 17 is a view of a middle pin in accordance with example embodiments;

FIG. 18 is a view of a forward pin in accordance with example embodiments;

FIGS. 19A-19C show a basic operation of the jack in accordance with example embodiments;

FIG. 20A is a perspective view of a jack in accordance with example embodiments;

FIG. 20B is a side view of a jack in accordance with example embodiments;

FIG. 20C is a top view of a jack in accordance with example embodiments;

FIG. 20D is a front view of a jack in accordance with example embodiments;

FIG. 21A is a top view of a first assembly in accordance with example embodiments;

FIG. 21B a side view of a first assembly in accordance with example embodiments;

FIG. 21C is a front view of a first assembly in accordance with example embodiments;

FIG. 22A is a view of an actuator in accordance with example embodiments;

FIG. 22B is another view of an actuator in accordance with example embodiments;

FIG. 22C is a view of an actuator attached to a first assembly in accordance with example embodiments;

FIG. 23A is a view of an actuator in accordance with example embodiments;

FIG. 23B is another view of an actuator in accordance with example embodiments;

FIG. 24A is a view of an actuator attached to a first assembly and a second assembly in accordance with example embodiments so that the jack is in a closed position; and

FIG. 24B is a view an actuator attached to a first assembly and a second assembly in accordance with example embodiments so that the jack is in an open position.

### DETAILED DESCRIPTION

Example embodiments of the invention will now be described with reference to the accompanying drawings. Example embodiments, however, should not be construed as limiting the invention since the invention may be embodied in different forms. Example embodiments illustrated in the figures are provided so that this disclosure will be thorough and complete. In the drawings, the sizes of components may be exaggerated for clarity.

In this application, when an element is referred to as being “on,” “attached to,” “connected to,” or “coupled to” another element, it can be directly on, attached to, connected to, or coupled to the other element or intervening elements that may be present. On the other hand, when an element is referred to as being “directly on,” “directly attached to,” “directly connected to,” or “directly coupled to” another element, there are no intervening elements present. As used herein, the term “and/or” includes any and all combinations of one or more of the associated listed items.

In this application, the terms first, second, etc. are used to describe various elements, components, regions, layers, and/or sections. However, these elements, components, regions, layers, and/or sections should not be limited by these terms since these terms are only used to distinguish one element, component, region, layer, and/or section from other elements, components, regions, layers, and/or sections that may be present. For example, a first element, component region, layer or section discussed below could be termed a second element, component, region, layer, or section.

In this application, spatial terms, such as “beneath,” “below,” “lower,” “over,” “above,” and “upper” (and the like) are used for ease of description to describe one element or feature's relationship to another element(s) or feature(s). The invention, however, is not intended to be limited by these spatial terms. For example, if an example of the invention illustrated in the figures is turned over, elements described as “over” or “above” other elements or features would then be oriented “under” or “below” the other elements or features. Thus, the spatial term “over” may encompass both an orientation of above and below. The device may be otherwise oriented (for example, rotated 45 degrees, 90 degrees, 180 degrees, or at other orientations) and the spatially relative descriptors used herein interpreted accordingly.

In this application, example embodiments may be described by referring to plan views and/or cross-sectional views which may be ideal schematic views. However, it is understood the views may be modified depending on manufacturing technologies and/or tolerances. Accordingly, the invention is not limited by the examples illustrated in the views, but may include modifications in configurations formed on the basis of manufacturing process. Therefore, regions illustrated in the figures are schematic and exemplary and do not limit the invention.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments are directed to a jack, for example, a trailer jack.

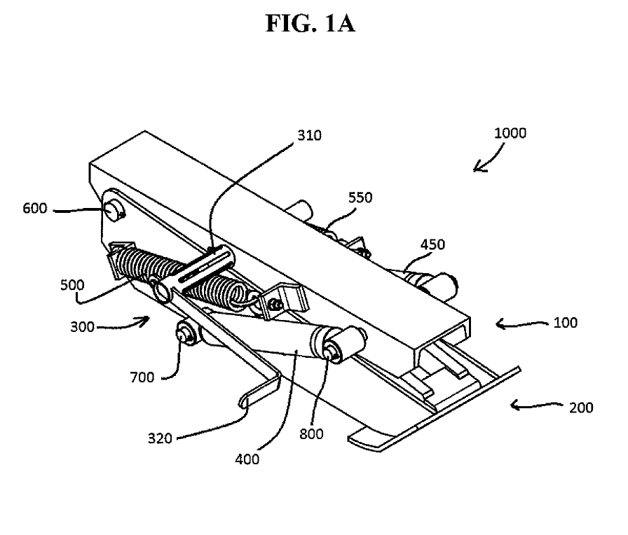

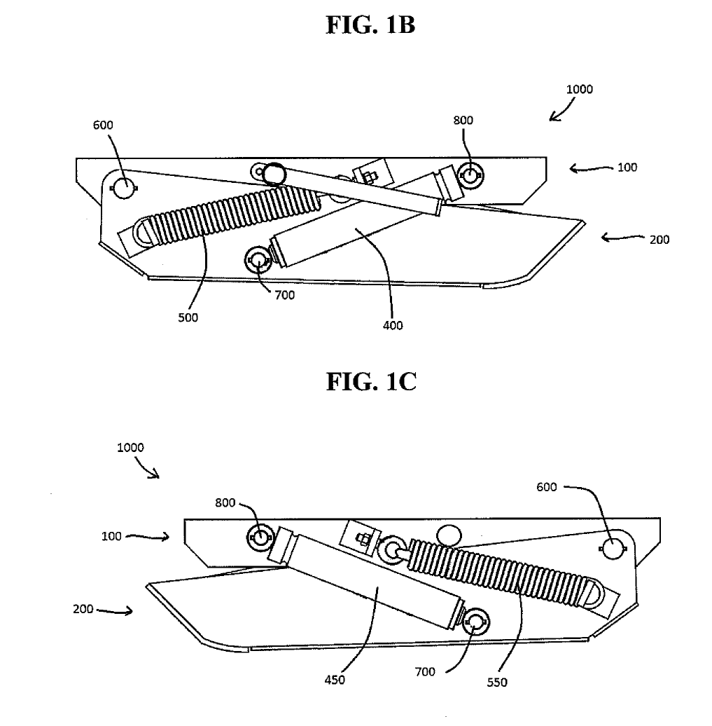

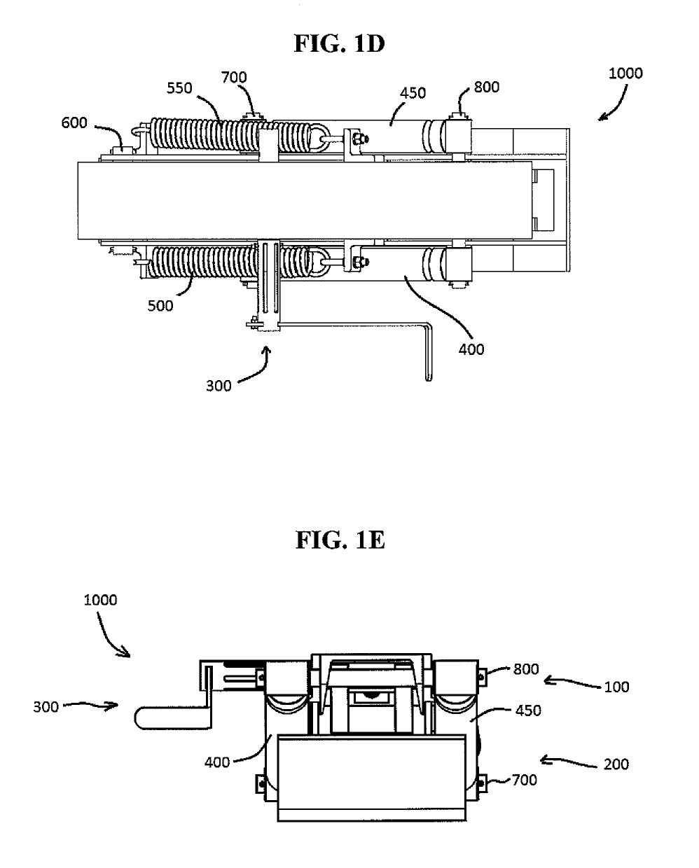

FIGS. 1A-1E are different views of a jack 1000 in accordance with example embodiments. For example, FIG. 1A is a perspective view of the jack 1000 in accordance with example embodiments, FIG. 1B is a first side view of the jack 1000 in accordance with example embodiments, FIG. 1C is a second side view of the jack 1000 in accordance with example embodiments, FIG. 1D is a top view of the jack 1000 in accordance with example embodiments, and FIG. 1E is a front view of the jack 1000 in accordance with example embodiments.

As shown in at least FIGS. 1A-1E, the jack 1000 may be comprised of a first assembly 100 connected to a second assembly 200 via a rear pin 600. Thus, in example embodiments, the first assembly 100 may rotate relative to the second assembly 200. In example embodiments, the pin 600 is illustrated as a separate component which may be held in place by a pair of roll pins (shown in the figures but not labeled), but example embodiments are not limited thereto. For example, the pin 600 may be fixed to the second assembly 200 by welding. As yet another example, the pin 600 may resemble a bolt having a head at one end and a threaded end at another end. In example embodiments, a nut may be provided to attach to the threaded end to secure the pin 600 in place.

In example embodiments, the jack 1000 may further include a first actuator 400 and a second actuator 450. In example embodiments, the first and second actuators 400 and 450 may be, but are not limited to, pneumatic or hydraulic cylinders. For example, the first and second actuators 400 and 450 may be, but are not limited to, hydraulic cylinders having a bore of 1.75 inches and a 10 inch stroke. In example embodiments, the first and second actuators 400 and 450 may be attached to the first and second assemblies 100 and 200 in such a way that they rotate at least one of the first assembly 100 and the second assembly 200 about the rear pin 600. For example, in the event the first and second actuators 400 and 450 are cylinders, for example, hydraulic cylinders, first ends of the first and second actuators 400 and 450 may be connected to the second assembly 200 via a middle pin 700 which may extend through the second assembly 200 and second ends of the first and second actuators 400 and 450 may be connected to the first assembly 100 via a forward pin 800 that may extend through the first assembly 100. Thus, in example embodiments, the jack 1000 may “open” as the first and second actuators 400 and 450 are extended, and closed as the first and second actuators 400 and 450 are contracted.

In example embodiments, a pair of biasing members 500 and 550 may be provided to bias the jack 1000 to a closed position. In example embodiments the biasing members 500 and 550 may be springs that may be in tension as the jack 1000 opens. In example embodiments, the biasing members 500 and 550 may have one end attached to the first assembly 100 via a spring angle and another end attached to the second assembly 200 via another spring angle. Although example embodiments illustrate a pair of biasing members 500 and 550, the invention is not limited thereto. For example, a single biasing member may be provided or more than two biasing members may be provided. Furthermore, the biasing members 500 and 550 illustrated as coil springs are not intended to limit the invention as other biasing members such as torsion springs may be provided instead. In addition, the biasing members 500 and 550 may be pretensioned springs meaning they may be in tension even when the jack 1000 is in the closed position.

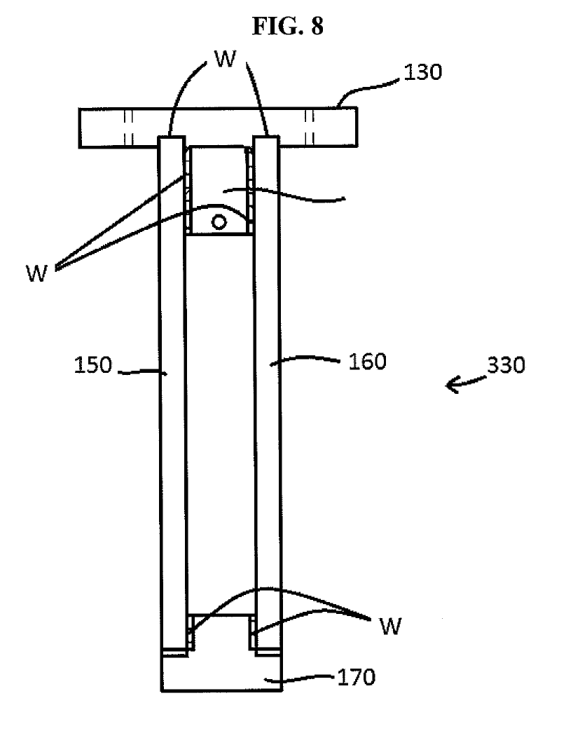

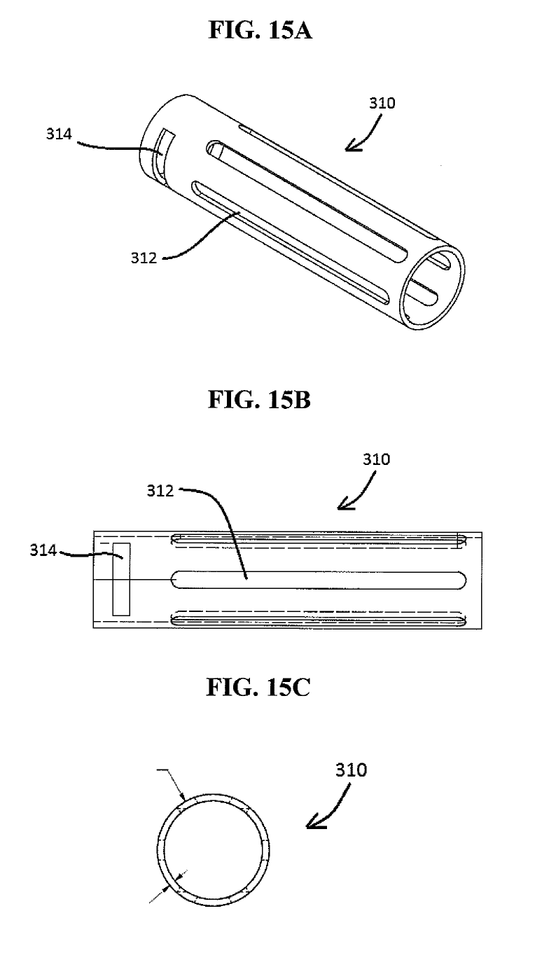

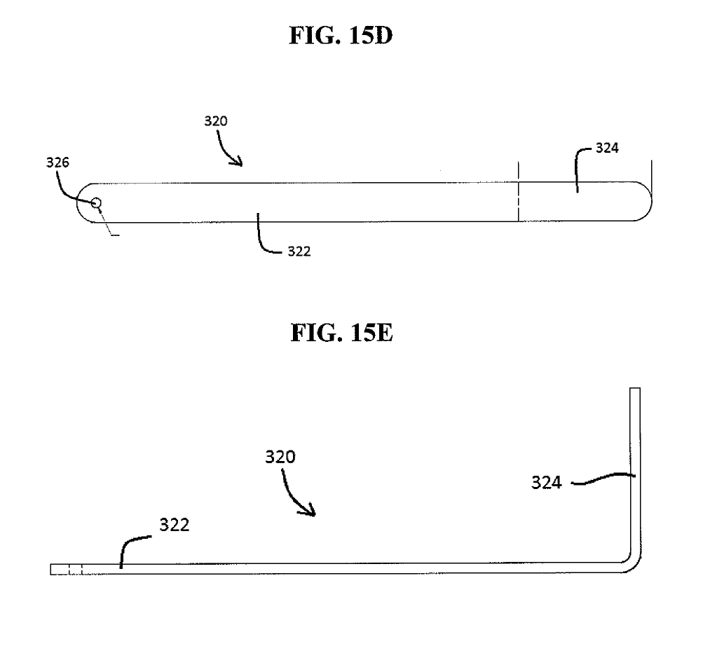

In example embodiments, the jack 1000 may further include a locking mechanism 300. The locking mechanism 300 may include a handle 320 connected to a locking assembly 330 (see FIG. 8) via a connector 310 (see FIGS. 15A-15C). The example locking mechanism 300 is for the purpose of illustration only. For example, rather than connecting the handle 320 to the locking assembly 330 via the connector 310, the handle 320 and the connector 310 may be constructed as a single piece by a casting process.

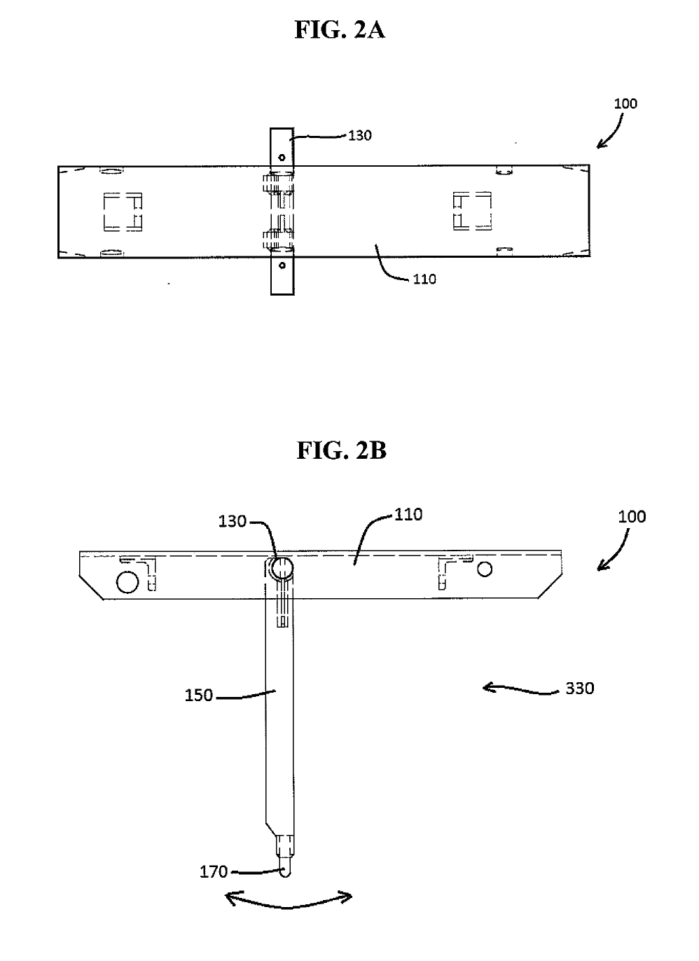

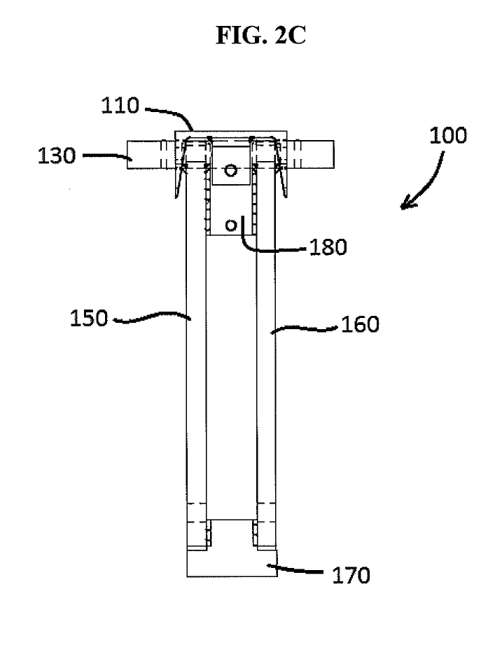

FIGS. 2A-C illustrate various views of the first assembly 100 in accordance with example embodiments. FIG. 2A, for example, is a top view of the first assembly 100, FIG. 2B is a side view of the first assembly 100, and FIG. 2C is a front view of the first assembly 100. Referring to FIGS. 2A and 2B, the first assembly 100 may be comprised of a base 110 and the locking assembly 330. In example embodiments, the locking assembly 330 may be comprised of a lock pin 130, a first arm 150, a second arm 160, a spring plate 180, and a lock bar plate 170. In FIG. 2B, the double-sided arrow indicates the locking assembling 330 is capable of “swinging” within the base 110.

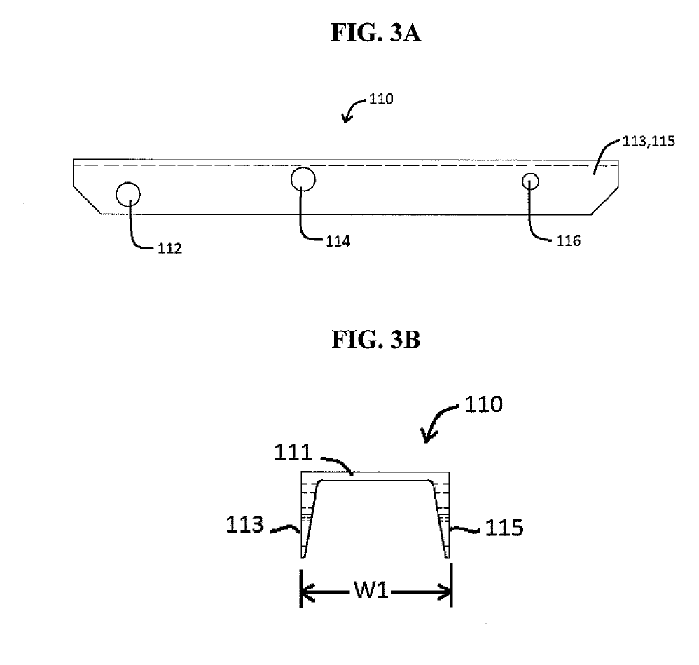

FIGS. 3A-3B illustrate an example of the base 110 in accordance with example embodiments. As illustrated in the figures, the base 110 may resemble a channel shaped member having two side sidewalls 113 and 115 connected by a substantially flat plate shaped member 111. The In example embodiments, the first side wall 113 may include a first hole 112 to accommodate the rear pin 600, a second hole 116 to accommodate the forward pin 800, and a third hole 114 to accommodate the lock pin 130. In example embodiments, the second side wall 115 may be substantially identical to the first side wall 113, thus, the second side wall may include holes corresponding to the first hole 112, the second hole 116, and the third hole 114. In example embodiments, each of the holes may be slightly larger than the pins of which they are associated with. For example, the first hole 112 may have a diameter of 1.53 inches when the rear pin 600 has a diameter of about 1.5 inches, the second hole 116 may have a diameter of about 1.03 inches when the forward pin 800 has a diameter of about 1 inch, and the third hole 114 may have a diameter of about 1.53 inches when the lock pin 130 has a diameter of about 1.5 inches. The aforementioned dimensions are not intended to limit example embodiments but are provided for purposes of illustration only.

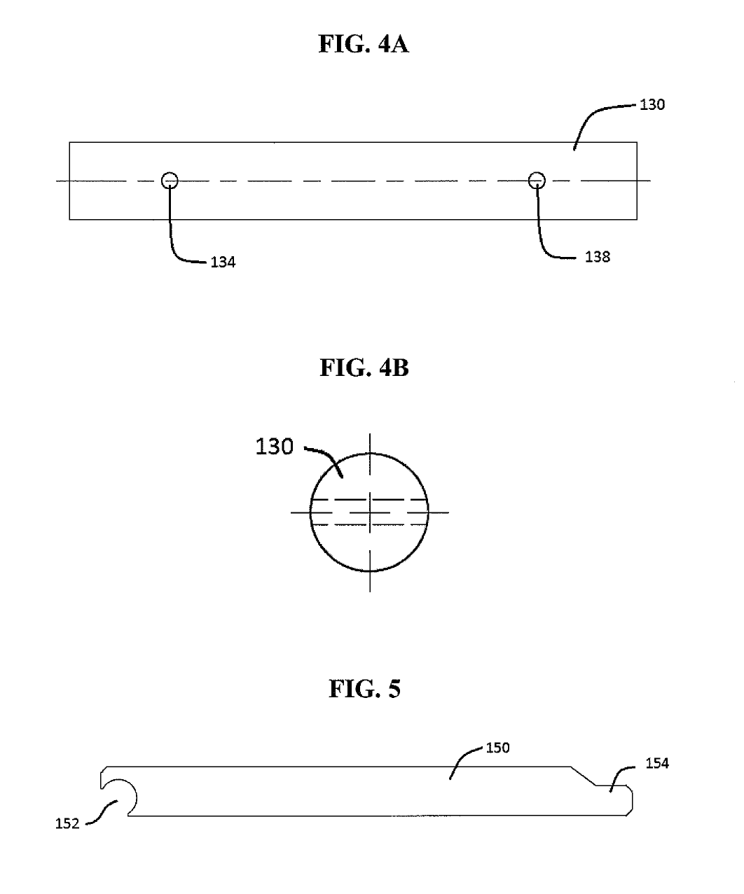

FIGS. 4A and 4B illustrate an example of the lock pin 130. As shown in FIGS. 4A and 4B, the lock pin 130 may resemble a cylindrical member configured to slide within the third hole 114 of the first side wall 113 and the corresponding hole in the second side wall 115. The lock pin 130, for example, may have a diameter of about 1.5 inches and a length of about 11 inches. In example embodiments, the lock pin 130 may include a pair of holes 134 and 138 which may be spaced so that when the lock pin 130 is inserted into the base 110, the pair of holes 134 and 138 will lie on the outsides of the two sidewalls 113 and 115. Thus, in example embodiments, a distance separating the pair of holes 134 and 138 may be about the same as, or larger than, a width W1 of the base 110. In example embodiments, the lock pin 130 may be locked in place by a pair of bolts or pins that pass through the pair of holes 134 and 138.

FIG. 5 is a view of the first arm 150 in accordance with example embodiments. As shown in FIG. 5, the first arm 150 may resemble a relatively long rectangular member with a first end 152 and a second end 154. In example embodiments, at least a portion of the first end 152 may be fabricated in such a manner that the first end 152 has a same general contour as the lock pin 130. For example, if the lock pin 130 is a cylindrical pin having an outer diameter of 1.5 inches, the first end 152 of the arm 150 may have semicircle shape having a radius of about 0.75 inches. In example embodiments, the second end 154 may serve as a location to which the lock bar plate 170 may be attached, for example, by welding. In example embodiments, the second arm 160 may substantially resemble the first arm 150, thus, a description thereof is omitted for the sake of brevity.

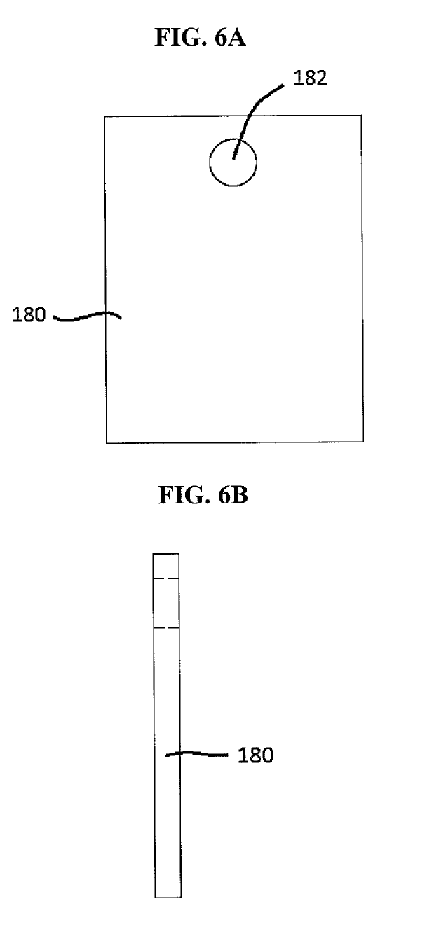

FIGS. 6A and 6B are views of an example of the spring plate 180 which may be arranged between the first arm 150 and the second arm 160. FIG. 6A, for example, is a plan view of the spring plate 180 and FIG. 6B is a side view of the spring plate 180. In example embodiments, spring plate 180 may resemble a rectangular plate with a hole 182 cut therethrough. In example embodiments, the spring plate 180 may serve to attach the first arm 150 to the second arm 160.

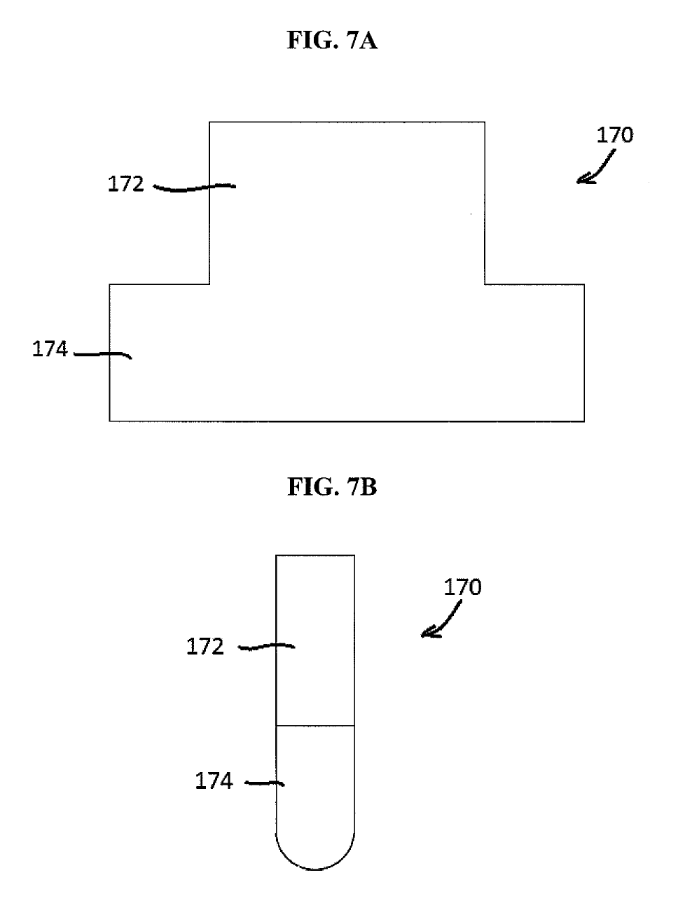

FIGS. 7A and 7B are views of an example of lock bar plate 170 which may be arranged near the second ends of the arms 150 and 160. As shown in FIG. 7A, the lock bar plate 170 may have a connecting area 172 and an interfacing area 174. The connecting area 172 may be used to connect the lock bar plate 170 to the second ends of the arms 150 and 160 and the interfacing area 174 may interface with saw toothed structures of the second assembly (to be explained later). In example embodiments, the lock bar plate 170 may have a substantially constant thickness but may also have a varying thickness. Further, the end of the lock bar plate 170 associated with the interfacing area 174 may have a curved profile to interface with the saw tooth structures.

FIG. 8 illustrates the locking assembly 330. As shown in FIG. 8, the locking assembly 330 may be formed by welding the arms 150 and 160 to the lock pin 130, by welding the spring plate 180 to the arms 150 and 160 and welding the second ends of the arms 150 and 160 to the lock bar plate 170 wherein the symbol W in FIG. 8 represents weld locations. In example embodiments, the weld locations W are provided for the purpose of illustration only and are not intended to limit example embodiments as other weld locations securing the various parts together may be used. In addition, the locking assembly 330 need not be fabricated by the above method. For example, a casting process may be used to manufacture a unitary piece having the above characteristics. Further yet, other methods, such as bolting and/or riveting, may be used to connect the various members together. In example embodiments, due to the nature of the connections, the locking assembly 330 will behave as a unitary structure. For example, if the lock pin 130 is rotated, lock bar plate 170 will revolve about an axis passing through the lock pin 130.

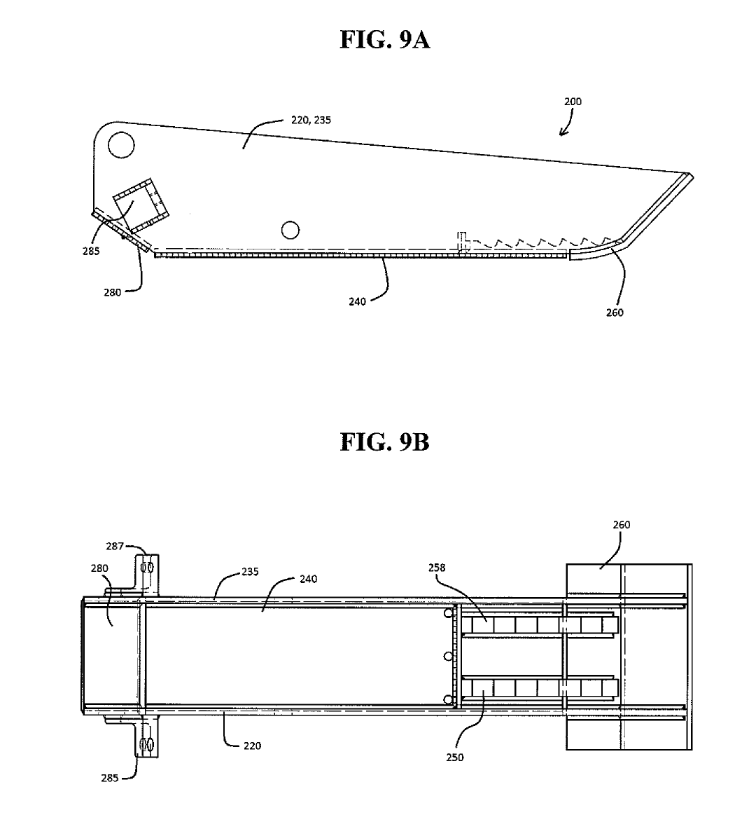

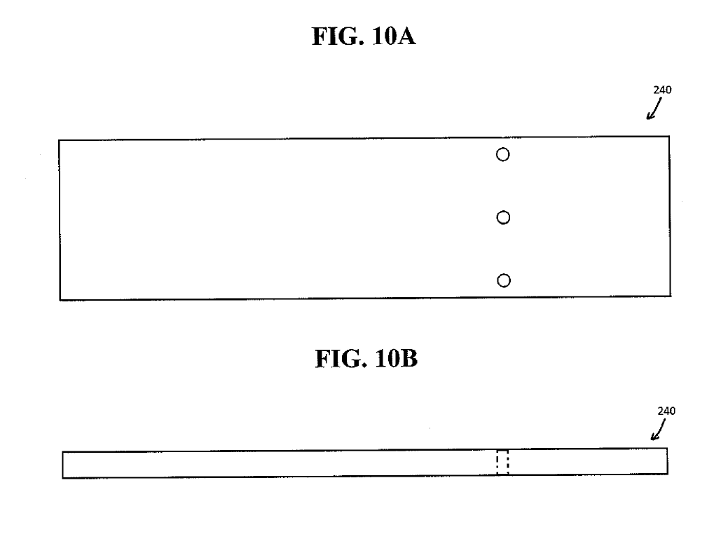

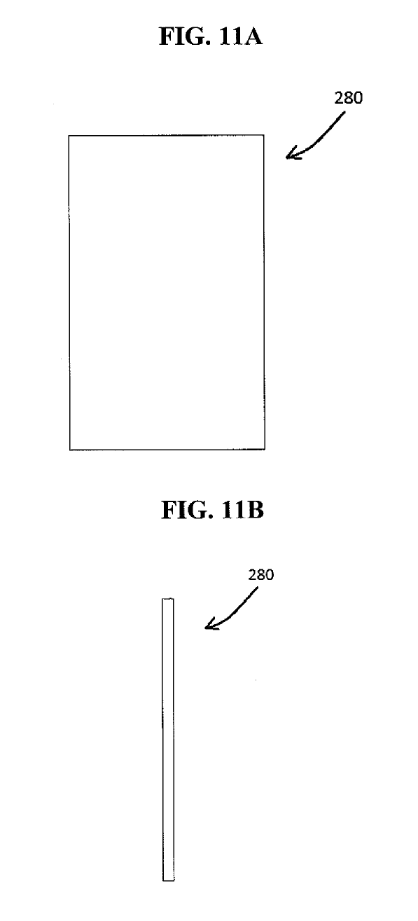

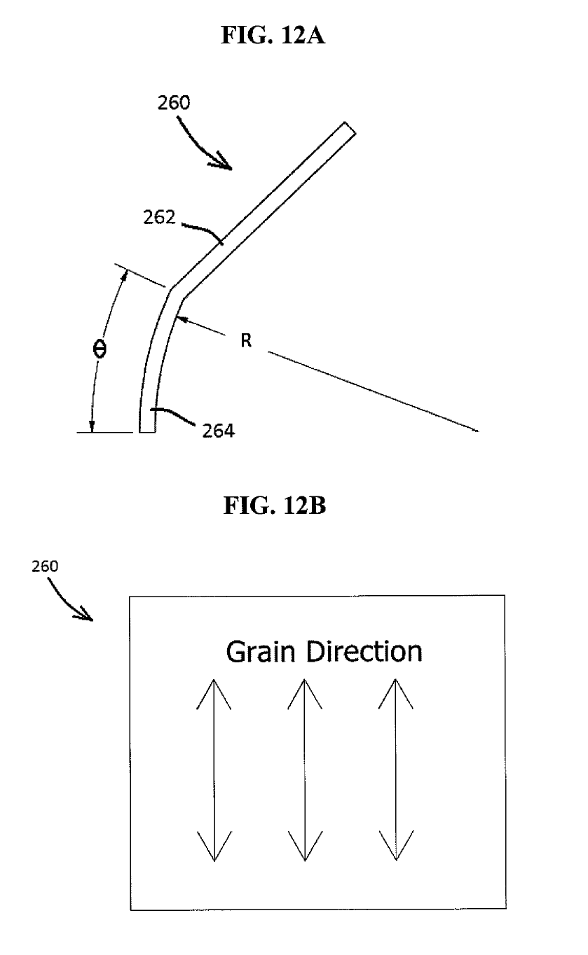

FIGS. 9A and 9B represent a first side view and a top view of the second assembly 200 in accordance with example embodiments. In example embodiments, the second assembly 200 may be comprised of a first side plate 220, a second side plate 235, a heel plate 280, a toe plate 260, a pair of saw tooth members 250 and 258, and a base plate 240. In example embodiments, the base plate 240 may serve as a structure to which other listed members may attach. As shown in FIGS. 10A and 10B, the base plate 240 may resemble a substantially rectangular plate with a substantially constant thickness. Example embodiments, however, are not limited thereto as the base plate 240 may have a varying thickness and may be formed to have a shape which is not substantially rectangular.

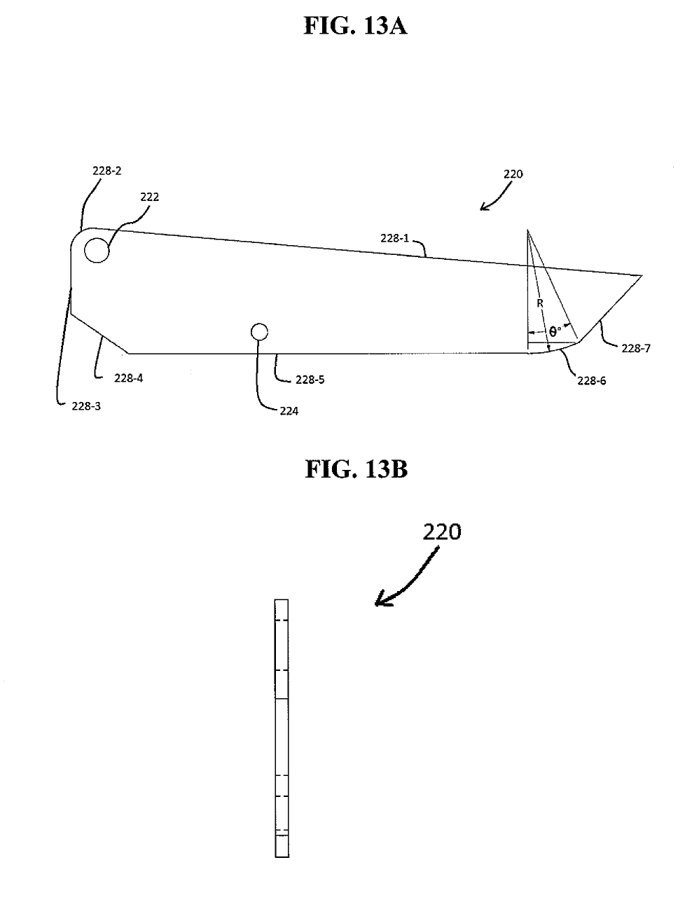

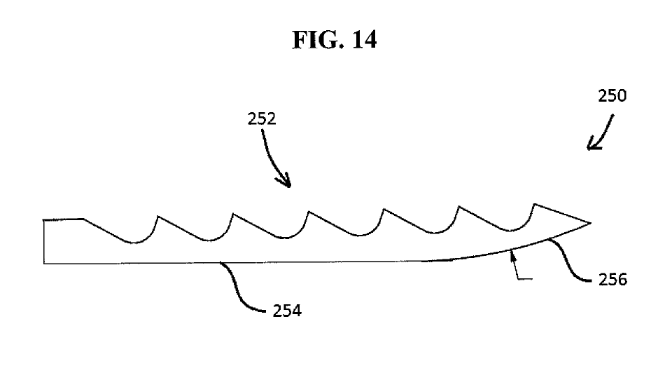

Referring to FIGS. 9A, 9B, 13A, and 13B, the first side plate 220 may resemble a polygon having a somewhat irregularly shaped perimeter comprised of seven edges. For example, in example embodiments, the first side plate 220 may have a first edge 228-1, a second edge 228-2, a third edge 228-3, a fourth edge 228-4, a fifth edge 228-5, a sixth edge 228-6, and a seventh edge 228-7. In example embodiments, the sixth edge 228-6 may be a curved edge having a radius of curvature R extending through an angle θ. For example, the radius of curvature of the sixth edge 228-6 may be about 7.75 inches which may span about 24 degrees. In example embodiments, the first side plate 220 may have a first hole 222 through which the rear pin 600 may pass and a second hole 224 through which the middle pin 700 may pass. In example embodiments, the second side plate 235 may have substantially the same configuration, thus, a detailed description thereof is omitted for the sake of brevity.

In example embodiments, the heel plate 280 may resemble a rectangular plate and may attach to the fourth edges 228-4 of the side plates 220 and 235. The heel plate 280, for example may attach to the side plates 220 and 235 by welding.

In example embodiments, the toe plate 260 may attach to the sixth and seventh edges 228-6 and 228-7 of the sides plates 220 and 240. In example embodiments, the toe plate 260 may have a curved portion 262 and a flat portion 264. The toe curved portion 262 for example, may have an inner radius of curvature R extending through an angle θ. For example, the inner radius of curvature of the curved portion 262 may be about 7.75 inches which may span about 24 degrees.

In example embodiments, the first sawtooth member 250 may have a serrated portion 252, a relatively flat portion 254, and a curved portion 256. The curved portion 256, for example, may have a radius of curvature of R which may be about 7.75 inches. Because the first saw tooth member 250 may have a substantially flat bottom surface 254 and a curved surface 256, the saw tooth member 250 may fit on both the base plate 240 and the toe plate 262. In example embodiments, the saw tooth member 250 may be cut from a plate type material, for example, a metal plate having a thickness of about 1.0 inches. Thus, the saw tooth member may have a constant thickness. Example embodiments, however, are not limited thereto as the saw tooth member is not required to have a constant thickness. In example embodiments, the second saw tooth member 258 may be substantially identical to the first saw tooth member 250, therefore, a description thereof is omitted for the sake of brevity. In example embodiments, two saw tooth members 250 and 258 are provided, however, example embodiments are not limited thereto. For example, a single saw tooth member configured to engage the lock bar plate 170 may be provided instead.

FIGS. 15A-15E illustrate various portions of a handle which may be attached to the locking assembly 330. The handle illustrated in FIGS. 15A-15E, however, is merely exemplary and is not intended to limit example embodiments. Referring to FIGS. 15A-15B, the handle may include the connector 310 which may be configured to attach to the lock pin 130. For example, in the event the lock pin 130 has an outer diameter of 1.5 inches, the inner diameter of the side connector 310 may be about 1.53 inches.

In example embodiments, the connector 310 may include a plurality of first slotted holes 312 extending along a length of the connector 310. In example embodiments, the first slotted holes 312 may facilitate a connection between the side connector 310 and the lock pin 130. For example, in example embodiments, the side connector 310 may be slid over an exposed portion of the lock pin 130 and a pin may be inserted through at least one of one of the holes of the first slotted holes 312 and through the first hole 134 of the lock pin 130 to secure the connector 310 to the lock pin 130.

In example embodiments, the side connector 310 may include a circumferential slot 314 which may be configured to receive and end of a handle 320. As shown in FIGS. 15D and 15E, the handle 320 may be formed from a substantially flat plat having a ninety degree bend imposed therein to form the grip 324 and the arm 322. In example embodiments, an end of the handle 320 may be formed with a hole 326 to receive a bolt to secure the handle 320 to the side connector 310.

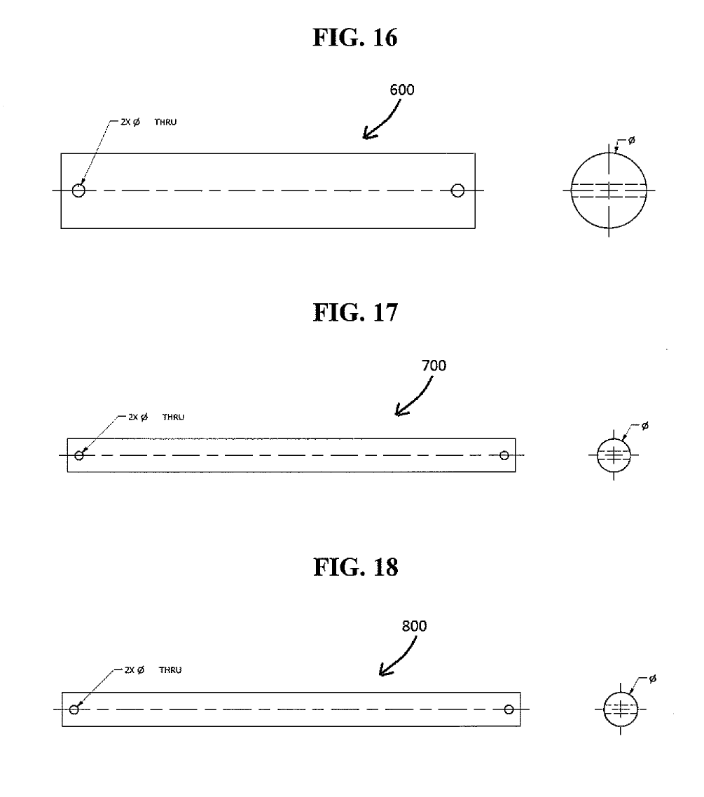

FIGS. 16-18 illustrate examples of the rear pin 600, the middle pin 700, and the forward pin 800. In example embodiments, each of the rear pin 600, the middle pin 700, and the forward pin 800 may resemble substantially solid cylinders having a circular cross section. In example embodiments, the rear pin 600, for example may have an outer diameter of about 1.5 inches and the middle and forward pins 700 and 800 may have outer diameters of about 1.0 inches. The aforementioned dimensions, however, are exemplary only and are not intended to limit example embodiments since the rear pin 600 may have an outer diameter greater than or less than 1.5 inches and the middle and forward pins 700 and 800 may have outer diameters of greater than or less than about 1.0 inch.

In example embodiments, the rear pin 600 may be configured to slide through hole 222 of the first side plate, the corresponding hole of the second side plate 235, as well as the first hole 112 of the side wall 113 and the corresponding hole of the side wall 115. In example embodiments, the rear pin 600 may include a pair of holes such that when the jack 1000 is assembled, the pair of holes may lie outside of the sidewalls 113 and 115 of the base 110 and outside of the first side plate 220 and the second side plate 235 of the second assembly 200. The holes may be configured to receive rolling pins to prevent the rear pin 600 from sliding through the aforementioned holes.

In example embodiments, the middle pin 600 may be configured to slide through hole 224 of the first side plate 220 and the corresponding hole of the second side plate 235. In example embodiments, the middle pin 600 may include a pair of holes such that when the jack 1000 is assembled, the pair of holes lies outside of the first side plate 220 and the second side plate 235 of the second assembly 200. The holes may be configured to receive rolling pins to prevent the middle pin 700 from sliding through the aforementioned holes.

In example embodiments, the forward pin 800 may be configured to slide through the third hole 116 of the side wall 113 and the corresponding hole of the side wall 115. In example embodiments, the forward pin 800 may include a pair of holes such that when the jack 1000 is assembled, the pair of holes lies outside of the sidewalls 113 and 115 of the base 110. The holes may be configured to receive rolling pins to prevent the forward pin 800 from sliding through the aforementioned holes.

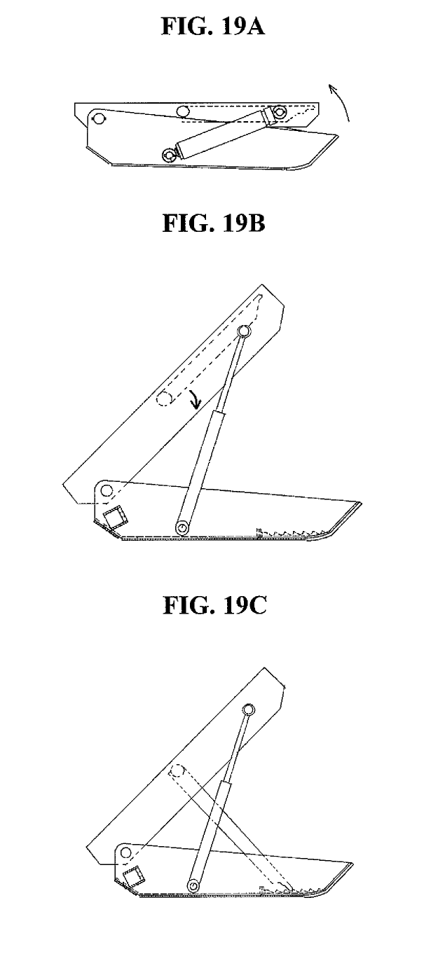

FIGS. 19A-19C partially illustrate the kinematics of the jack 1000. In FIG. 19A, the jack 1000 is shown in a closed position wherein the actuators 400 and 450 are in a retracted position. In FIG. 19B, the jack 1000 is shown in an open position wherein the actuators 400 and 450 are in an extended position. In FIG. 19B, jack 1000 is not in a locked position. However, in FIG. 19C, the locking assembly 330 is shown rotated downwards so that the lock bar plate 170 is engaged with the serrated edges of the saw tooth members 250 and 258. The locking assembly 330 may, for example, be rotated downwards manually via use of the handle 320 being connected to the side connector 310 which in turn is connected to the locking assembly 330.

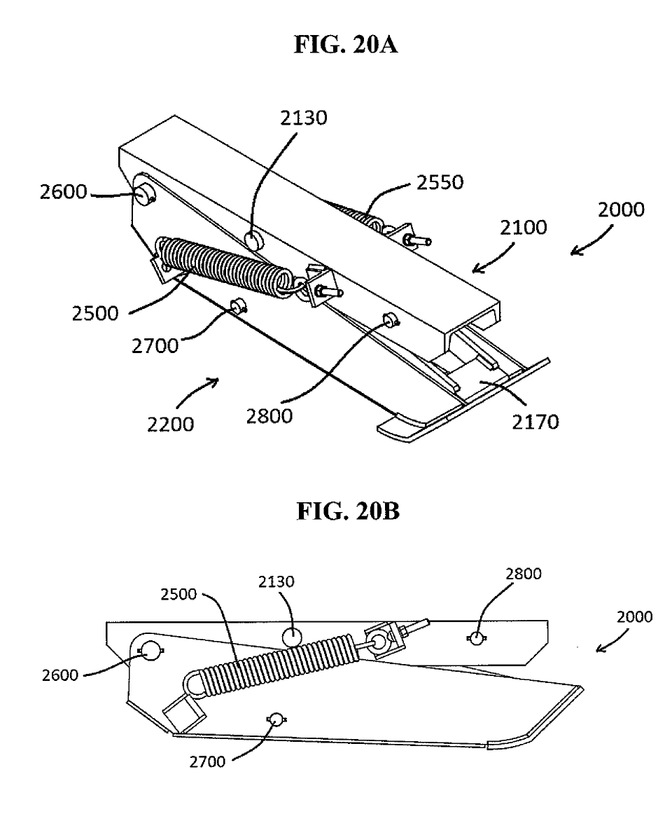

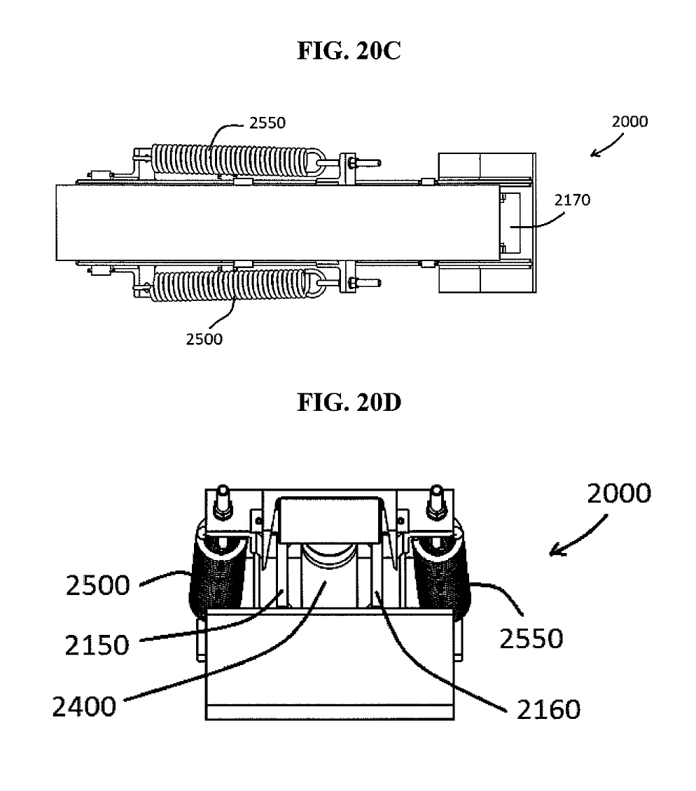

The invention is not intended to be limited by previously described example embodiments. FIG. 20A, for example, illustrates a perspective view of another jack 2000 in accordance with example embodiments. FIGS. 20B-20D illustrate a side view, a top view, and a front view of the jack 2000, respectively. In example embodiments, the jack 2000 share several features in common with the jack 1000. For example, the jack 2000 includes a first assembly 2100 and a second assembly 2200 pivotally connected to one another by a rear pin 2600. In example embodiments, the first assembly 2100 may be substantially identical to the first assembly 100 and the second assembly 2200 may be substantially identical to the second assembly 200, thus, only the differences will be highlighted.

Referring to FIGS. 20A-20D, the jack 2000 may include a least one biasing member configured to bias the first assembly 2100 towards the second assembly 2200. In example embodiments, the at least one biasing member may be, but is not required to be, a first spring 2500 and a second spring 2550 arranged to the sides of the first and second assemblies 2100 and 2200. Although the at least one biasing member is illustrated as including two coil springs, the at least one biasing member may alternatively include only one biasing member (for example one spring) may be provided or more than two biasing members (for example, three spring). Furthermore, the invention is not limited to biasing devices being comprised of coil springs, for example, the biasing devices may include other structures such as, but limited to, elastic cables, for example, rubber cables. IN the alternative, the at least one biasing member may be omitted in its entirety.

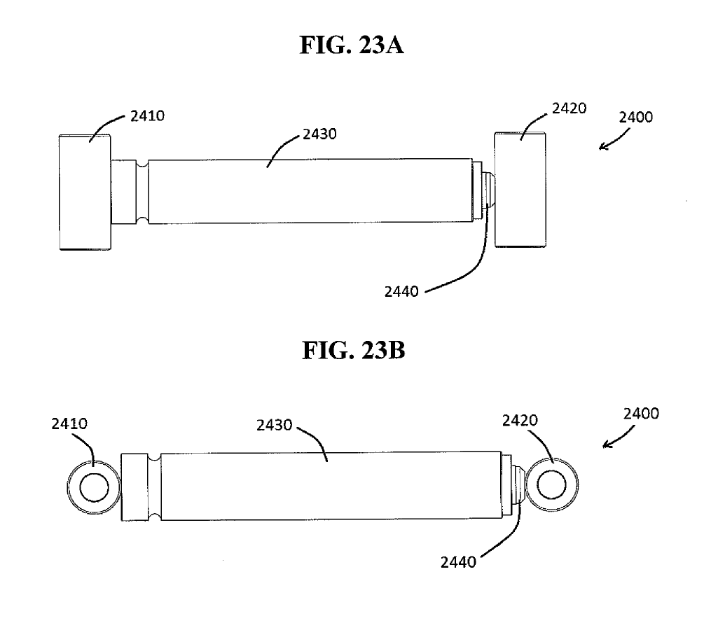

In example embodiments, the jack 2000 may further include an actuator 2400 configured to open and close the jack 2000. In example embodiments, the actuator 2400 may be, but is not required to be, a pneumatic or hydraulic cylinder. An example of the actuator 2400 is illustrated in FIGS. 23A and 23B. As shown in FIGS. 23A and 23B, the actuator 2400 may include a barrel 2430 and a rod 2440 as is commonly found in hydraulic or pneumatic cylinders. In example embodiments, an end of the barrel 2430 may include a first cylindrical member 2410 and an end of the rod 2440 may include a second cylindrical member 2420.

In example embodiments, the cylindrical members 2410 and 2420 may be configured to attach the actuator 2400 to the first and second assemblies 2100 and 2200. For example, in example embodiments the jack 2000 may include a middle pin 2700 that extends through the second assembly 2200 and a forward pin 2800 that extends through the first assembly 2100. In example embodiments the middle pin 2700 may be substantially identical to the middle pin 700 and the forward pin 2800 may be substantially identical to the forward pin 800. In example embodiments, actuator 2400 may be placed between (or inside) of the first and second assemblies 2100 and 2200 and the middle pin 2700 may be inserted into the first cylindrical member 2410 and the forward pin 2800 may inserted into the second cylindrical member 2420 to secure the actuator 2400 to the first and second assemblies 2100 and 2200. In example embodiments, diameters of the holes of the first and second cylindrical members 2410 and 2420 may be about the same size as, or larger than the diameters of the middle and forward pins 2700 and 2800 so that the ends of the actuator may rotate relative to the middle and forward pins 2700 and 2800. On the other hand, the first cylindrical member 2410 may be fixedly attached to the middle pin 2700, for example, by welding and/or pinning, and the second cylindrical member 2420 may be fixedly attached to the forward pin 2800, for example, by welding and/or pinning. In this latter embodiment, the forward pin 2800 may be configured to rotate within a pair of holes provided in the first assembly 2100 and the middle pin 2700 may be configured to rotated with a pair of holes in the second assembly 2200. Because each of the middle and forward pins 2700 and 2800 may rotate relative to the first and second assemblies 2100 and 2200, an extension or contraction of the rod 2440 in the barrel 2330 of the actuator 2400 would cause the first and second assemblies 2100 and 2200 to revolve about the rear pin 2600 to open and/or close the jack 2000.

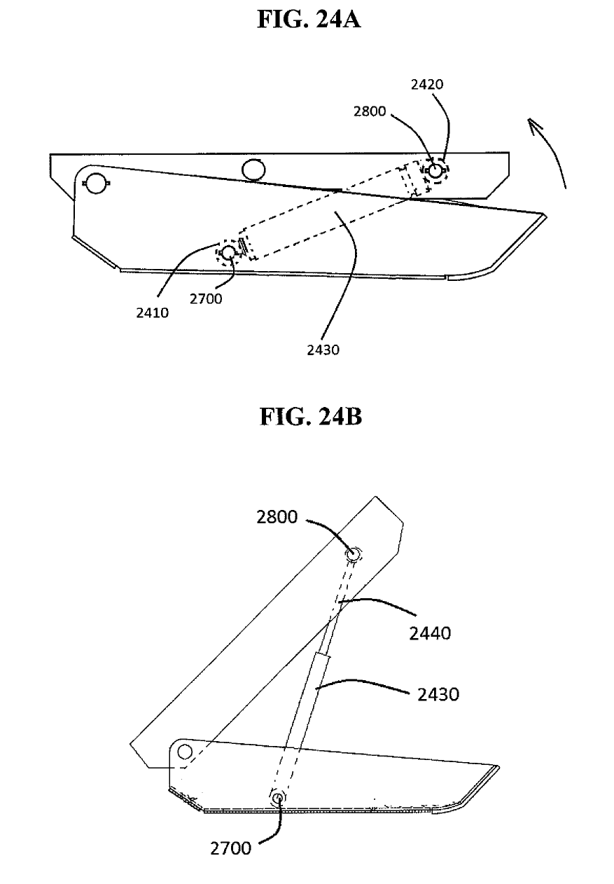

FIGS. 24A and 24B illustrate the jack 2000 with the actuator 2400 in a first position and an extended position. In the first position (see FIG. 24A) the rod 2440 is substantially in the barrel 2430 so that the jack may be in a closed position. In operation, the actuator 2400 may extend so that the first assembly 2100 is rotated away from the second assembly 2200 as shown in FIG. 24B.

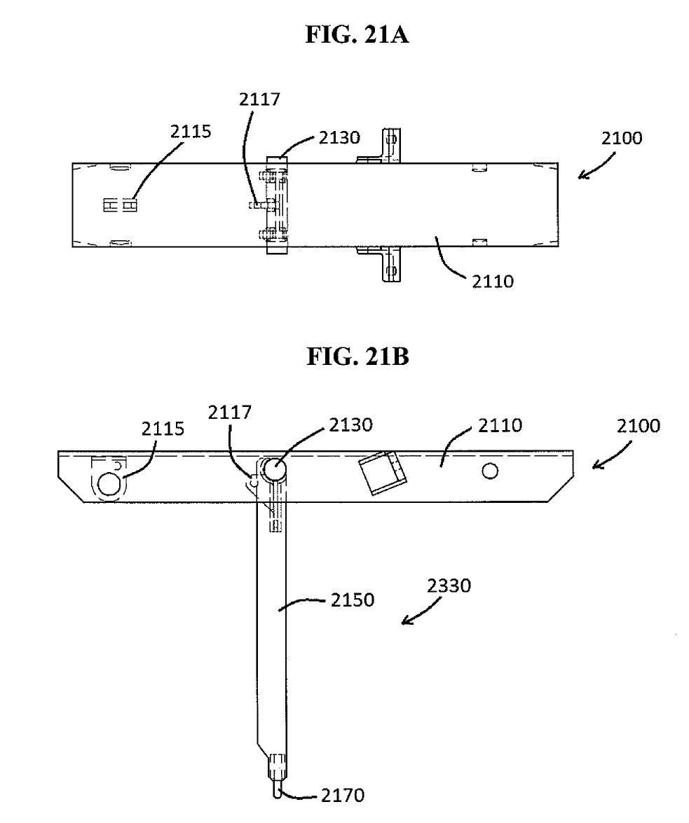

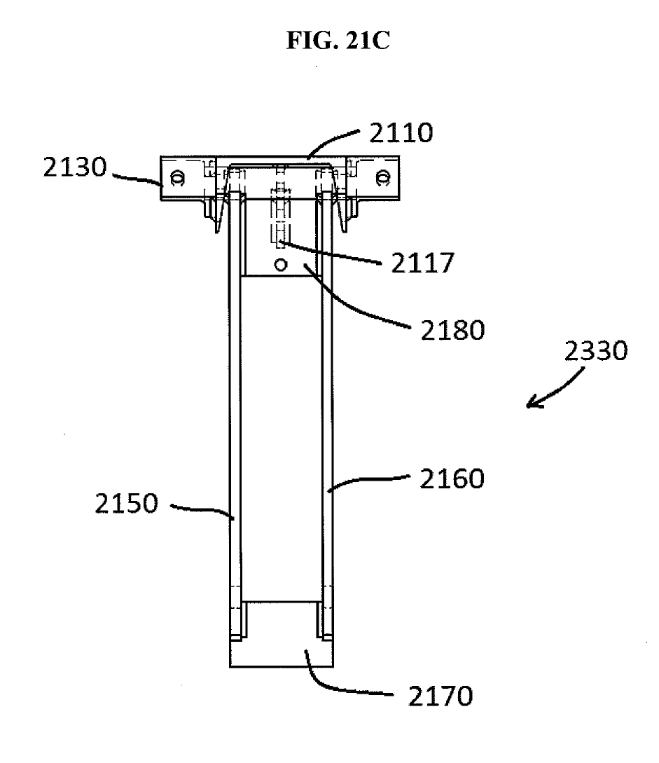

Similar to the jack 1000, the jack 2000 may include a locking assembly 2330 similar to the locking assembly 330. For example, the locking assembly 2330 may include a first arm 2150, a second arm 2160, a lock bar plate 2170, and a spring plate 2180 similar to the first arm 150, the second arm 160, the lock bar plate 170, and the spring plate 180, thus, a detailed description thereof is omitted for the sake of brevity. In example embodiments, the locking assembly 2330 may further include a lock pin 2130 pivotally supported by the first assembly 2100. For example, the first assembly 2100 may include side walls with holes therein configured to accommodate the lock pin 2130. in example embodiments, the lock pin 2130 may have a width wider than that of the first assembly 2100 as shown in FIG. 21A. In example embodiments, the first and second arm 2150 and 2160 may be attached to the lock pin 2130 so that the arms are pivotally attached to the first assembly 2100.

Unlike the locking assembly 330, the locking assembly 2330 may further include a first connecting structure 2117 that may serve as a first connecting structure for a second actuator 2450. The first connecting structure 2117, for example, may be attached to the spring plate 2180 of the locking assembly 2330. In example embodiments, the second actuator 2450 may be, but is not required to be, a pneumatic or hydraulic cylinder. In example embodiments, first assembly 2100 may include a second connecting structure 2115 to which the second actuator 2450 may attach. In example embodiments, each of the first and second connecting structures 2117 and 2115 may resemble plates having holes therein so that ends of the second actuator 2450 may attach to the locking assembly 2330 and the first assembly 2100.

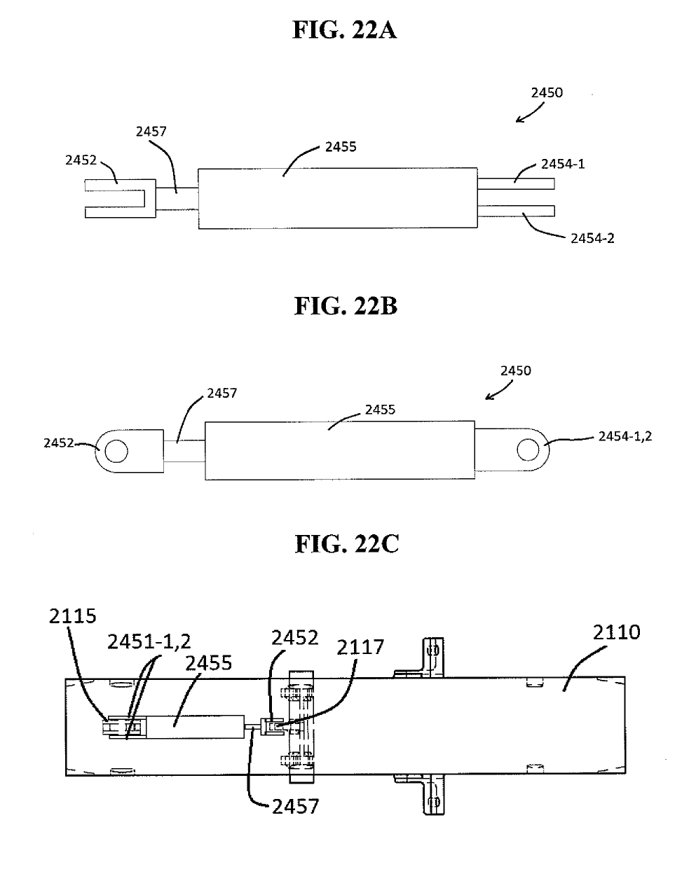

FIGS. 22A and 22B illustrate an example of the second actuator 2450. As shown in FIGS. 22A and 22B the second actuator 2450 may include a barrel 2455 and a piston 2457 which are commonly found in hydraulic and/or pneumatic cylinders. In example embodiments, an end of the piston 2457 may be fitted with a first collar 2452 which may attach to the first connecting structure 2117 by a pin. The barrel 2455 may include a pair of plates 2454-1 and 2454-2 which may attach to the second connecting structure 2115 by another pin. FIG. 22C illustrates the first assembly 2100 having the second actuator 2400 attached to the first and second structures 2117 and 2115. In example embodiments, operation of the second actuator 2450 causes the locking assembly 2330 to rotate. Thus, by controlling the second actuator 2450, a position of the locking assembly 2330 may be controlled.

In example embodiments, the arms 2150 and 2160 may be spaced far enough for the first actuator 2400 to pass therethrough. Thus, in example embodiments, the jack 2000 may be configured as a compact and substantially symmetrical structure wherein the opening and closing of the jack 2000 may be controlled by controlling a first actuator 2400 and a locking assembly 2330 may be controlled by operating a second actuator 2450. Though not specifically illustrated in the figures, it is understood that the second assembly 2200 may include a pair of saw tooth members similar to the pair of saw tooth members 250 and 258 and the lock bar 2170 may be configured to engage these saw tooth members similar to the manner in which the lock bar 170 engages the pair of saw tooth members 250 and 258.

Example embodiments illustrate examples of jacks 1000 and 2000 that may include a first assembly 100 and 2100, a second assembly 200 and 2200 pivotally connected to the first assembly 100 and 2100, a locking assembly 330 and 2330 pivotally connected to the first assembly 100 and 2100 and having an end 170 and 2170 configured to engage an interfacing member 250 arranged in the second assembly 200 (noting a structure similar to saw tooth members 250 may be in the second assembly 2200). Example embodiments also disclose the jacks 1000 and 2000 may have at least one actuator 400, 450, 2400 configured to rotate the first assembly 100, 2100 with respect to the second assembly 200, 2200.

In example embodiments the jacks 1000 and 2000 may include locking assemblies 330, 2330 that include a first arm 150 and 2150 and a second arm 160 and 2160. In example embodiments, the jack 2000 the at least one actuator is a single actuator 2400 arranged between the first and second arms 2150 and 2160. In example embodiments, the single actuator 2400 of the jack 1000 may be pivotally connected to the first and second assemblies 2100 and 2200.

In example embodiments, the jacks 1000 and 2000 may further include a first connecting structure 2117 on the locking assembly 2330 and a second connecting structure 2115 on the first assembly 2100. Although the jack 1000 is not illustrated as including these features, it is contemplated that the jack 1000 may also include these elements as well. Thus, in example embodiments, each of the jacks 1000 and 2000 may include a second actuator 2450, wherein operating the second actuator 2450 causes the first and second arms to revolve about an axis (which may be coincident with the pin 2130 or the corresponding pin 130). In example embodiments, this second actuator 2450 may be one of a pneumatic and hydraulic cylinder.

In example embodiments, the at least one actuator of jack 1000 may be a pair of actuators 400 and 450 arranged on the sides of the first and second assemblies 100 and 200. The jack 1000 may further include a handle 320 configured to actuate the locking assembly 330. Though not shown in the figures, it is understood the jack 2000 may also be configured to include a handle similar to handle 320 to actuate the locking assembly 2330. In this latter embodiment, the actuator 2450 may not be required. In example embodiments, the handle 320 may be configured to rotate the at least one arm 150 into a position such that the end interfaces the interfacing member 250. In example embodiments, the interfacing member 250 may include a serrated surface 252.

In example embodiments, the actuators 400, 450, and 2400 may be single acting actuators or double acting actuators. For example, in example embodiments, the actuators 400, 450, and 2400 may be double acting hydraulic or pneumatic cylinders or single acting hydraulic or pneumatic cylinders. In the event the actuators 400, 450 and 2400 are double acting actuators, an opening or closing of the jacks 1000 and 2000 may be controlled by controlling the double acting actuators 400, 450, and 2400. For example, in the event the actuators 400, 450, and 2400 are double acting hydraulic or pneumatic cylinders the opening and closing of the jacks 1000 and 2000 may be controlled by controlling the position of a rod in a cylinder. In this latter embodiment, biasing members 500, 550, 2500, and 2550 may be omitted since the jacks 1000 and 2000 may be open or closed using the double acting actuators 400, 450, and 2400. In the event the actuators 400, 450, and 2400 are single acting actuators, the biasing members 500, 550, 2500, and 2550 may be necessary to transition the jacks 1000 and 2000 from an open position to a closed position or from a closed position to an open position. In example embodiments, the second actuator 2450 may also be one of a single or double acting actuator. For example, the second actuator 2450 may be, but is not required to be, a double acting hydraulic or pneumatic cylinder.

While example embodiments have been particularly shown and described with reference to example embodiments thereof, it will be understood by those of ordinary skill in the art that various changes in form and details may be made therein without departing from the spirit and scope of the invention.

What we claim is:

1. A jack comprising:
a first assembly;
a second assembly pivotally connected to the first assembly;
a locking assembly pivotally connected to the first assembly and having an end configured to engage an interfacing member arranged in the second assembly; and
at least one actuator configured to rotate the first assembly with respect to the second assembly.

2. The jack according to claim 1, wherein the locking assembly includes a first arm.

3. The jack according to claim 2, wherein the locking assembly includes a second arm.

4. The jack according to claim 3, wherein the at least one actuator is a single actuator arranged between the first and second arms.

5. The jack according to claim 4, wherein the single actuator is pivotally connected to the first and second assemblies.

6. The jack according to claim 3, further comprising:
a first connecting structure on the locking assembly;
a second connecting structure on the first assembly; and
a second actuator, wherein operating the second actuator causes the first and second arms to revolve about an axis.

7. The jack according to claim 3, wherein the second actuator is one of a pneumatic and hydraulic cylinder.

8. The jack according to claim 2, wherein the at least one actuator is a pair of actuators arranged on the sides of the first and second assemblies.

9. The jack according to claim 8, further comprising:
a handle configured to actuate the locking assembly.

10. The jack according to claim 9, wherein the handle is configured to rotate the at least one arm into a position such that the end interfaces the interfacing member.

11. The jack according to claim 10, wherein the interfacing member includes a serrated surface.

12. The jack according to claim 1, wherein the at least one actuator is a double acting actuator.

13. The jack according to claim 12, wherein the at least one actuator is one of a pneumatic and a hydraulic cylinder.

14. The jack according to claim 12, further comprising:
a second actuator configured to pivot the locking assembly.

15. The jack according to claim 14, wherein the second actuator is one of a single acting and double acting actuator.

16. The jack according to claim 15, wherein the second actuator is one of a pneumatic and hydraulic cylinder.

17. The jack according to claim 14, wherein one end of the second actuator is connected to the first assembly and a second end of the actuator is connected to the locking assembly.
